(19) United States
(12) Patent Application Publication
(10) Pub. No.: US 2010/0013440 A1
(43) Pub. Date: Jan. 21, 2010

(54) Rechargeable Battery with Active Over-Temperature Protection and Related Method and Power Supply System

(76) Inventor: Jin-En Liao, Taipei City (TW)

Correspondence Address: NORTH AMERICA INTELLECTUAL PROPERTY CORPORATION, P.O. BOX 506, MERRIFIELD, VA, 22116, US

(21) Appl. No.: 12/436,768

(22) Filed: May 6, 2009

(30) Foreign Application Priority Data
Jul. 18, 2008 (TW) 097127327

(51) Int. Cl. H02J 7/04

(52) U.S. Cl. 320/152; 320/150

(57) ABSTRACT

A rechargeable battery with active over-temperature protection includes an energy storage unit for storing energy provided by a recharging device, a temperature sensing unit coupled to the energy storage unit for sensing temperature of the energy storage unit in order to generate a temperature sensing signal, and an insertion status unit coupled to the temperature sensing unit for outputting an indication signal to the recharging device so as to control operations of the recharging device.

### BACKGROUND OF THE INVENTION

1. Field of the Invention

The present invention relates to a rechargeable battery with active over-temperature protection and related method and power supply system, and more particularly, to provide a rechargeable battery with active over-temperature protection via an indication signal and related method and power supply system.

2. Description of the Prior Art

With technological advancements, portable electronic devices, such as notebooks, personal digital assistants, etc, have several advantages, including small size, light weight, and convenience for carrying due to their portability. For enhancing portability, most of portable electronic devices are equipped with rechargeable batteries. When the power of the batteries is exhausted, a user needs to charge the batteries for replenishing power of the batteries. However, temperatures of the batteries may be different while charging due to different electric current. As a large amount of electric current is used to charge batteries, the batteries may become too hot. If the batteries become too hot, the batteries may result thermal runaway, and thus cause the batteries or the peripherals damage, even endangering the user.

Therefore, having protection management for the rechargeable battery is important. Please refer to the FIG. 1 FIG. 1 is a schematic diagram of a power supply system 10 in the prior art. The power supply system 10 includes a system host 102, a recharging device 104, and a rechargeable battery 106. In the power supply system 10, the system host 102 is responsible for managing the power supply system 10. The recharging device 104 is utilized for providing energy. The rechargeable battery 106 includes an energy storage unit 108 and a power management circuit 110. The energy storage unit 108 is utilized for storing energy provided by the recharging device. The power management circuit 110 is utilized for managing the recharging process. The power management circuit 110 measures a related value while recharging, and transmits the measured values to the system host 102, then the system host 102 calculates whether over-temperature has occurred by the measured values. After that, the system host 102 determines the next protection procedure, for example, shut down the recharging device 104.

However, in the prior art, if the power management circuit 110 and the system host 102 fail to communicate with each other, the over-temperature procedure may not be performed with certainty. On the other hand, an error code is not included in the common power management chip (such as BQ2060) or Smart Battery System standard, so that when a thermal sensing element utilized for sensing temperature in the power management circuit 110 is abnormal, the abnormality will not be discovered. Otherwise, the thermal sensing element is usually installed in the integrated chip, but location of the thermal sensing element is usually not able to approach the energy storage unit 108 because of mechanism design, causing inaccurately measured values. As a result, the above-mentioned problem will fail to perform over-temperature protection for the battery and cannot avoid the over-temperature situation, so as to damage the rechargeable battery itself and peripheral devices.

### SUMMARY OF THE INVENTION

It is therefore a primary objective of the claimed invention to provide a rechargeable battery with active over-temperature protection and related method and power supply system.

The present invention discloses a rechargeable battery with active over-temperature protection, which includes an energy storage unit for storing energy provided by a recharging device, a temperature sensing unit coupled to the energy storage unit for sensing temperature of the energy storage unit in order to generate a temperature sensing signal, and an insertion status unit coupled to the temperature sensing unit for outputting an indication signal to the recharging device according to the temperature sensing signal so as to control operations of the recharging device.

The present invention further discloses an over-temperature protection method for a rechargeable battery, which includes coupling the rechargeable battery to a recharging device by insertion, sensing a temperature of an energy storage unit of the rechargeable battery in order to generate a temperature sensing signal, and outputting an indication signal to the recharging device so as to control operations of the recharging device according to the temperature sensing signal.

The present invention further discloses a power supply system with active over-temperature protection which includes a recharging device for providing energy, a detecting processing unit coupled to the recharging device for detecting coupling status of the recharging device so as to control operations of the recharging device according to an indication signal, and a rechargeable battery capable of being coupled to a portable electronic device by insertion for providing operating power for the portable electronic device, wherein the rechargeable battery includes an energy storage unit coupled to the recharging device for storing energy provided by the recharging device, a temperature sensing unit coupled to the energy storage unit for sensing temperature of the energy storage unit in order to generate a temperature sensing signal, and an insertion status unit coupled to the temperature sensing unit for outputting an indication signal to the detecting processing unit according to the temperature sensing signal so as to control operations of the recharging device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a power supply system in the prior art.

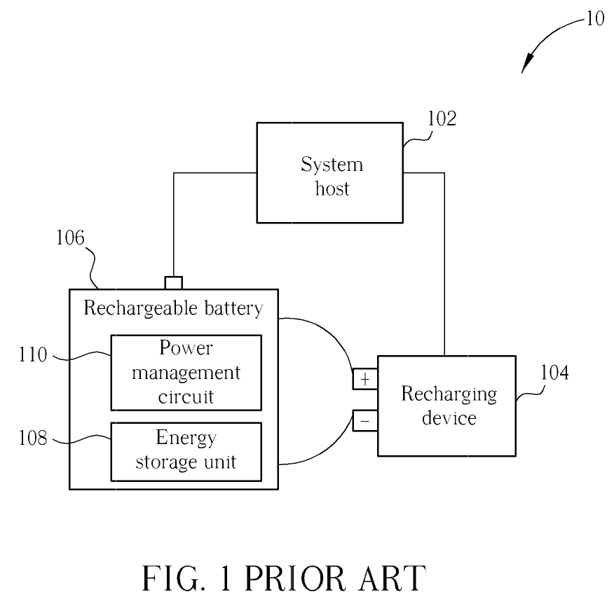

FIG. 2 is a schematic diagram of a power supply system according to an embodiment of the present invention.

FIG. 3 is a schematic diagram of a recharging procedure according to an embodiment of the present invention.

### DETAILED DESCRIPTION

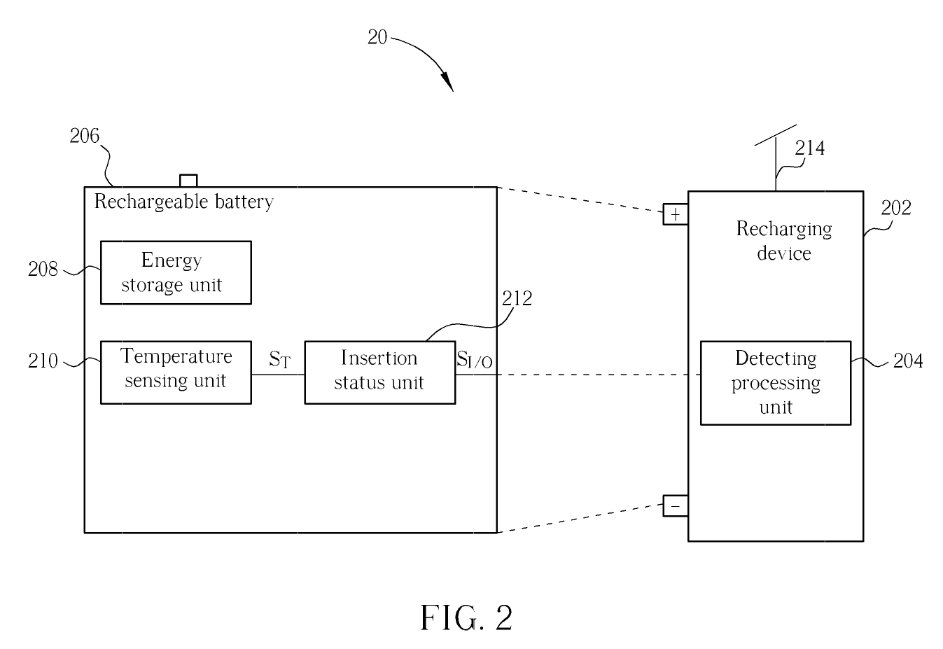

Please refer to the FIG. 2 FIG. 2 is a schematic diagram of a power supply system 20 according to an embodiment of the present invention. The power supply system 20 is capable of providing active over-temperature protection while recharging a portable device. The portable device is preferably a notebook or a personal digital assistant, etc., but is not a limitation of the present invention. The power supply system 20 includes a recharging device 202, a detecting processing unit 204, and a rechargeable battery 206. The recharging device 202 is utilized for providing energy. The detecting processing unit 204 is coupled to the recharging device 202 for detecting coupling status so as to control operations of the recharging device 202 according to an indication signal S_{I/O}. The rechargeable battery 206 is capable of being coupled to a portable electronic device by insertion for providing operating power for the portable electronic device. The rechargeable battery 206 includes an energy storage unit 208, a temperature sensing unit 210, and an insertion status unit 212. The energy storage unit 208 is coupled to the recharging device 202 for storing energy provided by the recharging device 202.The temperature sensing unit 210 is coupled to the energy storage unit 208 for sensing temperature of the energy storage unit 208 in order to generate a temperature sensing signal S_{T}. The insertion status unit 212 is coupled to the temperature sensing unit 210 for outputting the indication signal S_{I/O} to the detecting processing unit 204 according to the temperature sensing signal S_{T} SO as to control operations of the recharging device 202. In addition, the power supply system 20 can further comprise an external power slot 214 for receiving external power. The recharging device 202 is capable of being coupled to the external power slot 214 for transforming the external power in order to charge the rechargeable battery 206.

Furthermore, in the embodiment of the present invention, the temperature sensing unit 210 is direct coupled to the energy storage unit 208 and real-time senses temperature of the energy storage unit 208 in order to generate the temperature sensing signal S_{T}. The temperature sensing signal S_{T} is preferably a voltage signal. Moreover, the indication signal S_{I/O} includes an insertion indication signal S_{IN} and a removing indication signal S_{OUT}. The insertion indication signal S_{IN} is utilized for notifying the detecting processing unit 204 that the rechargeable battery 206 is being coupled to the recharging device 202 so that the recharging device 202 can provide energy to the rechargeable battery 206. The removing indication signal S_{OUT} is utilized for notifying the detecting processing unit 204 that the rechargeable battery 206 has been removed from the recharging device 202 so that the recharging device 202 can stop providing energy for the rechargeable battery 206. When the temperature sensing signal S_{T} shows that temperature of the energy storage unit 208 is above a threshold temperature, the insertion status unit 212 outputs the removing indication signal S_{OUT} into the recharging device 202 so as to control the recharging device 202 to stop providing energy to the energy storage unit 208. Comparatively, when the temperature sensing signal S_{T} shows that temperature of the energy storage unit 208 is under a threshold temperature, the insertion status unit 212 outputs the insertion indication signal S_{IN} into the recharging device 202 so as to control the recharging device 202 to keep providing energy to the energy storage unit 208.

Therefore, the present invention is capable of outputting the indication signal S_{I/O} into the detecting processing unit 204 according to the temperature sensing signal S_{T} of the temperature sensing unit 210 so as to control operations of the recharging device 202. In such a condition, the embodiment of the present invention needs not to passively transmit the measured temperature information to the system host for estimation.

Note that, the power supply system 20 is an exemplary embodiment of the present invention, and those skilled in the art can make alternations and modifications accordingly. For example, the detecting processing unit 204 can be integrated in the recharging device 202. Therefore, the temperature sensing unit 210 can be implemented by a thermal sensing element, such as thermistor, thermal sensing diode, thermal sensing integrated circuit, etc, but these are not limitations of the present invention. Those skilled in the art should appreciate that various other thermal sensing elements can be used. Because impedance of a thermistor varies with temperature, for example, the impedance of a thermistor having a critical temperature resistor increases with rising temperature while the temperature is above a critical temperature. Therefore, the embodiment of the present invention can utilize the characteristic of the thermistor to generate the indication signal S_{I/O} of the insertion status unit 212 to notify the detecting processing unit 204 and stop providing energy to the energy storage unit 208, when the energy storage unit 208 has unusual temperature variation due to recharging procedure. Thus, through the embodiment of the present invention, the temperature sensing unit 210 can be close to the energy storage unit 208 for sensing temperature so that the temperature sensing unit 210 is capable of real-time responding actual operating temperature to the insertion status unit 212 for over-temperature protection.

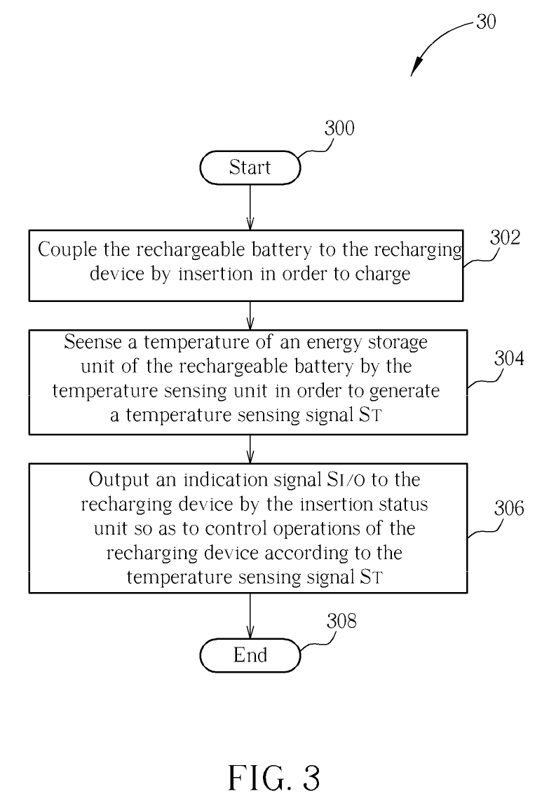

As to an operating procedure of the power supply system 20 shown in FIG. 2, please refer to FIG. 3. FIG. 3 is a schematic diagram of a recharging procedure 30 according to an embodiment of the present invention. The procedure 30 comprises the following steps:

Step 300: Start.

Step 302: Couple the rechargeable battery 206 to the recharging device 202 by insertion in order to charge.

Step 304: Sense a temperature of an energy storage unit 208 of the rechargeable battery 206 by the temperature sensing unit 210 in order to generate a temperature sensing signal S_{T}.

Step 306: Output an indication signal S_{I/O} to the recharging device 202 by the insertion status unit 212 so as to control operations of the recharging device 202 according to the temperature sensing signal S_{T}.

Step 308: End.

The procedure 30 illustrates operation of the power supply system 20. The temperature sensing unit 210 senses the temperature of the energy storage unit 208, and the insertion status unit 212 outputs an indication signal S_{I/O} to the recharging device 202 direct to indicate whether the recharging device 202 operates after determining over-temperature state.

In summary, the prior art needs to passively transmit the measured temperature information to the system host for estimation so as to implement over-temperature protection. In contrast to the prior art, the embodiment of the present invention can be close to the energy storage unit to accurately respond actual operating temperature, and more importantly, to actively output an indication signal to the recharging device to control operations of the recharging device direct according to the result of the temperature sensing unit, having a real-time and reliable over-temperature protection.

Those skilled in the art will readily observe that numerous modifications and alterations of the device and method may be made while retaining the teachings of the invention.

What is claimed is:

1. A rechargeable battery with active over-temperature protection comprising:
an energy storage unit for storing energy provided by a recharging device;
a temperature sensing unit coupled to the energy storage unit for sensing temperature of the energy storage unit in order to generate a temperature sensing signal; and
an insertion status unit coupled to the temperature sensing unit for outputting an indication signal to the recharging device according to the temperature sensing signal so as to control operations of the recharging device.

2. The rechargeable battery of claim 1, wherein the temperature sensing unit is a thermistor.

3. The rechargeable battery of claim 2, wherein the temperature sensing signal is voltage signal.

4. The rechargeable battery of claim 1, wherein the indication signal comprises an insertion indication signal and a removing indication signal.

5. The rechargeable battery of claim 4, wherein the insertion status unit outputs the removing indication signal into the recharging device so as to control the recharging device to stop providing energy to the energy storage unit when the temperature sensing signal shows temperature of the energy storage unit above a threshold temperature.

6. The rechargeable battery of claim 4, wherein the insertion status unit outputs the insertion indication signal into the recharging device so as to control the recharging device to keep providing energy to the energy storage unit when the temperature sensing signal shows temperature of the energy storage unit under a threshold temperature.

7. An over-temperature protection method for a rechargeable battery, comprising:
coupling the rechargeable battery to a recharging device by insertion;
sensing a temperature of an energy storage unit of the rechargeable battery in order to generate a temperature sensing signal; and
outputting an indication signal to the recharging device so as to control operations of the recharging device according to the temperature sensing signal.

8. The over-temperature protection method of claim 7, wherein the indication signal comprises an insertion indication signal and a removing indication signal.

9. The over-temperature protection method of claim 8, wherein outputting the indication signal to the recharging device so as to control operations of the recharging device according to the temperature sensing signal comprises outputting the removing indication signal into the recharging device so as to control the recharging device to stop providing energy to the energy storage unit when the temperature sensing signal shows temperature of the energy storage unit above a threshold temperature.

10. The over-temperature protection method of claim 8, wherein outputting the indication signal to the recharging device so as to control operations of the recharging device according to the temperature sensing signal comprises outputting the insertion indication signal into the recharging device so as to control the recharging device to keep providing energy to the energy storage unit when the temperature sensing signal shows temperature of the energy storage unit under a threshold temperature.

11. A power supply system with active over-temperature protection comprising:
a recharging device for providing energy;
a detecting processing unit coupled to the recharging device for detecting coupling status of the recharging device so as to control operations of the recharging device according to an indication signal; and
a rechargeable battery capable of being coupled to a portable electronic device by insertion for providing operating power for the portable electronic device, wherein the rechargeable battery comprises:
an energy storage unit coupled to the recharging device for storing energy provided by the recharging device;
a temperature sensing unit coupled to the energy storage unit for sensing temperature of the energy storage unit in order to generate a temperature sensing signal; and
an insertion status unit coupled to the temperature sensing unit for outputting an indication signal to the detecting processing unit according to the temperature sensing signal so as to control operations of the recharging device.

12. The power supply system of claim 11 further comprising an external power slot for receiving external power.

13. The power supply system of claim 12, wherein the recharging device is utilized for transforming the external power in order to charge the rechargeable battery.

14. The power supply system of claim 11, wherein the detecting processing unit is integrated in the recharging device.

15. The power supply system of claim 11, wherein the temperature sensing unit is a thermistor.

16. The power supply system of claim 15, wherein the temperature sensing signal is voltage signal.

17. The power supply system of claim 11, wherein the indication signal comprises an insertion indication signal and a removing indication signal.

18. The power supply system of claim 17, wherein the insertion status unit outputs the removing indication signal into the recharging device so as to control the recharging device to stop providing energy to the energy storage unit when the temperature sensing signal shows temperature of the energy storage unit above a threshold temperature.

19. The power supply system of claim 17, wherein the insertion status unit outputs the insertion indication signal into the recharging device so as to control the recharging device to keep providing energy to the energy storage unit when the temperature sensing signal shows temperature of the energy storage unit under a threshold temperature.
